(19) United States
(12) Patent Application Publication
(10) Pub. No.: US 2007/0038518 A1
(43) Pub. Date: Feb. 15, 2007

(54) Image processing apparatus and method

(75) Inventor: Tetsuya Yokoyama, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/441,025

(22) Filed: May 26, 2006

(30) Foreign Application Priority Data
Jun. 8, 2005 (JP) 2005-168416

(51) Int. Cl. G06Q 20/00

(52) U.S. Cl. 705/23

(57) ABSTRACT

Disclosed is an image processing apparatus in which when a scanning job for which a fee is charged is executed, utilization of scanned data by a user who has not paid the fee can be prevented and it is possible to avoid a situation in which a user who has paid the fee cannot utilize the scanned data. The apparatus scans in a document by a scanner to thereby generate data, encodes the data using a password and stores the encoded data in an external storage device. Next, the apparatus executes fee-charging processing to charge the price for the chargeable scanning job. After the charging processing is executed, the apparatus prints out a password used when the stored encrypted data is to be decoded.

### FIELD OF THE INVENTION

The present invention relates to an image processing apparatus, such as a digital multifunction peripheral, and an image processing method for executing a scanning job for which a fee is charged.

### BACKGROUND OF THE INVENTION

Digital multifunction peripherals having a scanner function and a printer function and utilized upon being connected to a network such as the Internet or a LAN have come into widespread use in recent years. Such digital multifunction peripherals find use not only in offices but also in public spaces such as convenience stores and schools.

In general, a digital multifunction peripheral that has been installed in a public space is equipped with a fee-charging device that charges a fee for copy processing or print processing in order to collect the fee directly from the user who pays the fee when the user causes the copying or printing to be executed. Recent digital multifunction peripherals are now being provided not only with this function but also with a function that charges for execution of scan processing itself (e.g., see the specifications of Japanese Patent Application Laid-Open Nos. 2003-244349 and 2002-330253).

In a digital multifunction peripheral that executes such a scan function for which a fee is charged, conceivable destinations where scanned-in image data can be saved (stored) are memory media such as Compact Flash (registered trademark) media or the hard-disk drive of a computer connected via a network.

If such a digital multifunction peripheral is so configured that the fee is accepted after the scanned image data has been stored on portable memory media removably inserted into the digital multifunction peripheral or on the hard disk of an external computer connected via a network, the fee that accompanies scan processing may not be collected accurately in the event of such behavior as withdrawal of the memory media or disconnection of the network connection to the external computer during the storing of the scanned image data. Further, with a method that accepts the fee after scan processing ends but before the scanned image data is stored, the fee may be collected without the user obtaining the scanned image data in the event that the storage destination of the scanned image data does not have enough storage capacity.

### SUMMARY OF THE INVENTION

Accordingly, an object of the present invention is to so arrange it that when a scanning job for which a fee is charged is executed, utilization of scanned image data by a user who has not paid the fee can be prevented and it is possible to avoid a situation in which a user who has paid the fee cannot utilize the scanned image data.

According to the present invention, the foregoing object is attained by providing an image processing apparatus for executing a chargeable scanning job, comprising: a data generating unit adapted to scan a document and generate data; an encrypting unit adapted to encrypt the data and generate encrypted data; a charging unit adapted to execute charging processing with regard to price of the chargeable scanning job after the encrypted data has been stored at a predetermined storage destination; and an output unit adapted to outputting information necessary when the encrypted data that has been stored at the storage destination is decrypted, after the charging processing is executed.

Further, according to the present invention, the foregoing object is attained by providing an image processing method for executing a chargeable scanning job, comprising: a data generating step of scanning a document and generating data; an encrypting step of encrypting the data and generating encrypted data; a charging step of executing charging processing with regard to price of the chargeable scanning job after the encrypted data has been stored at a predetermined storage destination; and an output step of outputting information necessary when the encrypted data that has been stored at the storage destination is decrypted, after the charging processing is executed.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the hardware configuration of an image processing apparatus such as a digital multifunction peripheral according to an embodiment of the present invention;

FIG. 2 is a block diagram illustrating the hardware configuration of an image processing system constructed on a network to which an image processing apparatus according to this embodiment of the invention has been connected;

FIG. 3 is a flowchart for describing operation when a chargeable scanning job is performed using an image processing apparatus according to this embodiment; and

FIG. 4 is a diagram illustrating an example of a dialog box displayed on a display unit of an image processing apparatus according to this embodiment when a fee insufficiency has occurred.

### DETAILED DESCRIPTION OF THE PREFERRED EMBODIMENT

A preferred embodiment of the present invention will now be described in detail with reference to the drawings. It should be noted that the relative arrangement of the components, the numerical expressions and numerical values set forth in these embodiments do not limit the scope of the present invention unless it is specifically stated otherwise.

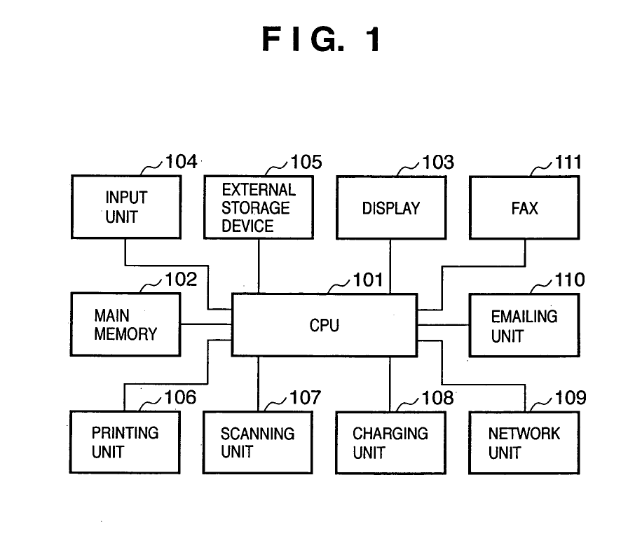

FIG. 1 is a block diagram illustrating the hardware configuration of an image processing apparatus such as a digital multifunction peripheral according to an embodiment of the present invention. As illustrated in FIG. 1, an image processing apparatus according to this embodiment includes a central processing unit 101, a main memory 102, a display unit 103, an input unit 104, an external storage device 105, a printing unit 106, a scanning unit 107, a charging unit 108, a network unit 109, an emailing unit 110 and a fax unit 111.

The central processing unit 101 controls the main memory 102, display unit 103, input unit 104, external storage device 105, printing unit 106, scanning unit 107, charging unit 108, network unit 109, emailing unit 110 and fax unit 111 and performs arithmetical and logical operations.

The main memory 102 stores information necessary for the image processing apparatus of this embodiment to execute various image processing and is capable of extracting this information as required. The display unit 103, which is implemented by a CRT or liquid-crystal panel, displays the results of processing such as figures, text and scanned image data and notification screens to present the user with warning displays and various items of notification. Further, the input unit 104, which is for making various inputs to the central processing unit 101, is implemented by a keyboard, mouse or card reader, etc. The input unit 104 may be implemented by providing the display unit 103 such as a CRT or liquid-crystal panel with a touch-sensitive panel.

The external storage device 105 stores scanned image data, which has been encrypted, as well as other information. Examples of storage devices that can be used are a magnetic storage device, magneto-optical storage device and removable media such as portable media removably inserted into the image processing apparatus.

The printing unit 106 prints the results of processing such as figures, text and images on a printing medium such as paper. In this embodiment, as will be described later, the printing unit 106 prints out a password, which is auxiliary information necessary when decrypting scanned image data that has been encrypted. Further, the scanning unit 107 scans image information, etc., which has been formed on a paper document, thereby converting the information to electronic information. The scanned image data that has been read is encrypted using a password. The charging unit 108 executes processing to charge a prescribed fee as the price of executing chargeable jobs such as copy processing, print processing and scan processing implemented by the various units and devices within the image processing apparatus according to this embodiment.

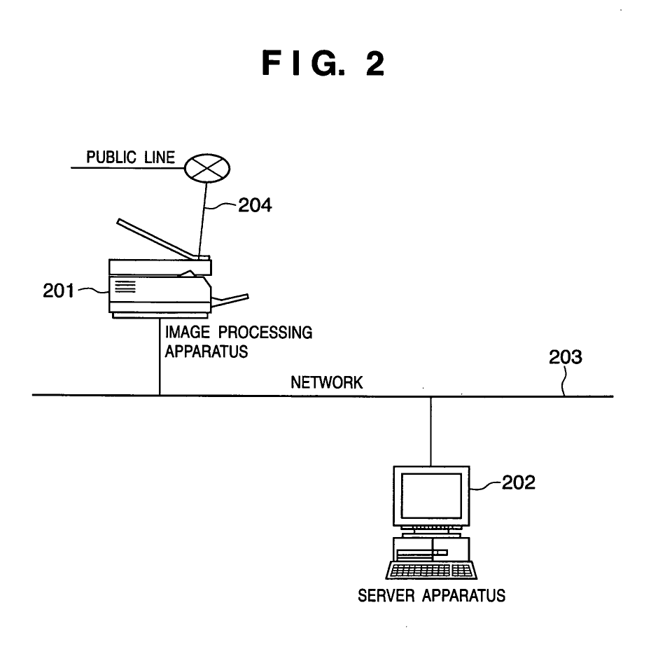

The network unit 109 connects the image processing apparatus to an external computer connected via a network such as the Internet or LAN, thereby making it possible to communicate data between the computer and the image processing apparatus. The emailing unit 110 has a transceive function for sending and receiving e-mail to and from the outside via the network. The fax unit 111 has a fax transceive function for sending and receiving fax signals to and from the outside via a public line (WAN) 204, as illustrated in FIG. 2.

FIG. 2 is a block diagram illustrating the hardware configuration of an image processing system constructed on a network to which an image processing apparatus according to this embodiment has been connected. In this embodiment, it is assumed that the system executes processing that includes encrypting image data that has been read by an image processing apparatus 201 the details of the structure of which are shown in FIG. 1, transmitting the encrypted image data to a server apparatus 202 and storing the data in an external storage device of the server apparatus 202. Examples of the external storage device of the server apparatus 202 are a hard disk in the server apparatus 202 and removable media such as portable memory media removably inserted into the server apparatus 202.

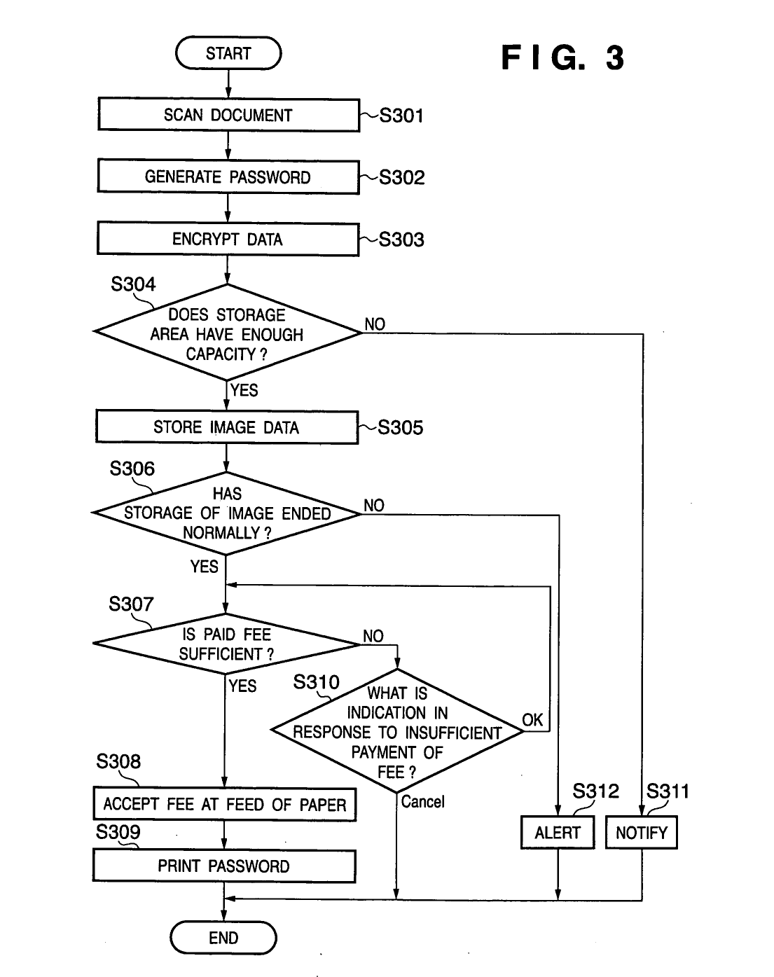

FIG. 3 is a flowchart for describing operation when a chargeable scanning job is performed using an image processing apparatus according to this embodiment.

First, if a user instructs the scanner 107 to scan a document, the scanner 107 executes scanning of the document (step S301). Next, the CPU 101 generates a password for encrypting the image data that has been generated by the scanning of the document (step S302). In this embodiment, it is assumed by way of example that the password is generated based upon the MAC address of the network unit 109 and date and time (hour, minute and second) of generation of the image data. However, the present invention is not limited to this example.

Next, the CPU 101 encrypts the scanned image data using the password generated at step S302 (step S303). In this embodiment, the CPU 101 utilizes RC4, etc., developed by RSA Security, as the algorithm for executing encryption processing, inputs the generated password and performs encryption.

Next, the CPU 101 determines whether the external storage device of the server apparatus 202 connected via network 203 has sufficient capacity for storing the encrypted image data (step S304). In this embodiment, it is assumed that a removable medium prepared by the user is utilized as the external storage device of the server apparatus 202, the available capacity is compared with the amount of scanned image data that has been encrypted and it is determined whether the scanned image data is capable of being stored. If the result of the determination is that the external storage device has sufficient capacity for storing scanned image data (“YES” at step S304), the CPU 101 causes the network unit 109 to transmit the encrypted image data to the server apparatus 202. The transmitted image data is saved (stored) in the external storage device of the server apparatus 202 (step S305).

On the other hand, if it is determined at step S304 that the amount of scanned image data is so large that it cannot be stored in the external storage device of the server apparatus 202 (“NO” at step S304), the CPU 101 so notifies the user (step S311) and terminates processing. It should be noted that means of notifying the user include utilizing the display unit 103 to display on a screen the fact that the image data cannot be stored on the removable medium of the user, and informing the user by voice of the fact that the image data cannot be stored on the removable medium, by way of example. Here it may be so arranged that if the user has replaced the removable medium with a new one, control returns to the decision step S304 and similar determination processing is executed. It should be noted that the above-described operation is performed through a similar procedure also in a case where the scanned image data is stored in the external storage device 105.

It should be noted that if it is found at step S304 that the amount of scanned image data is greater than the capacity of the area of the removable medium in which data can be stored, then processing is terminated without execution of charging processing because the scanned image data is not saved in the removable medium.

When the scanned image data that has been encrypted is saved in the external storage device of the server apparatus 202 at step S305, the CPU 101 determines whether storage of the scanned image data ended normally (step S306). In this embodiment, the destination at which the scanned image data is stored is the external storage device of the server apparatus 202 connected to the image processing apparatus 201 via the network 203. The above-mentioned determination, therefore, is performed by monitoring the state of the connection to the network 203. It should be noted that if the destination at which the scanned image data is stored is the external storage device 105 of the image processing apparatus 201, then the determination is performed by monitoring the state of the connection to the external storage device 105. In either case, mutilation of the data storage area is monitored as well.

If it is determined at step S306 that storage of the scanned image data did not end normally (“NO” at step S306), then the CPU 101 alerts the user (step S312) and terminates processing. Means of alerting the user include utilizing the display unit 103 to display on a screen the fact that the storage of the image data did not end normally, and informing the user of this fact by voice. In order for the thus alerted user to obtain the scanned image data, it is necessary for the user to contact the installer or administrator of the image processing apparatus 201, give notification of the problem and execute the main processing again after execution of appropriate processing.

In a case where storage of the scanned image data on the removable medium has ended abnormally, there is a possibility that the user will not have obtained the complete results of processing of the image data desired by the user. For this reason, processing is terminated without execution of processing for charging the user. Even if storage of the scanned image data on the removable medium has been performed part of the way, the image data has been stored in encrypted form and the password for decrypting the data has not been reported to the user, as a result of which decryption is impossible. Accordingly, even if the user intentionally suspends the storage operation in mid-course, charging processing is not executed, although the user does not obtain the desired results either. It is possible without use of the decryption password to delete the encrypted image data that has been stored on the removable medium and to restore the removable medium to the state that prevailed prior to storage of the image data.

If it is determined at step S306 that storage of the scanned image data ended normally (“YES” at step S306), on the other hand, then the CPU 101 determines whether the fee necessary in order to execute the processing of the chargeable scanning job has been introduced to the charging unit 108 (step S307). If the fee necessary for executing scan processing has been introduced (“YES” at step S307), then the charging unit 108 accepts the fee necessary for scan processing (step S308). The printing unit 106 prints the password needed in order to decrypt the encrypted image data that has been stored in the external storage device 105 (step S309). It should be noted that by executing the charging processing of step S308 at the timing at which the printing unit 106 feeds paper in order to print out the password on the paper, it becomes possible to notify the user of the password after the fee has been charged with certainty. Further, in this embodiment, it is assumed that the decryption password used is identical with the password that was generated at step S302 (namely the password that was used in the encryption processing). However, it may be so arranged that a separate password is used. In addition, notification of the password may be performed by displaying the password using the display unit 103.

The user can obtain the desired data by using the reported password to decode the scanned image data that has been stored on the removable medium.

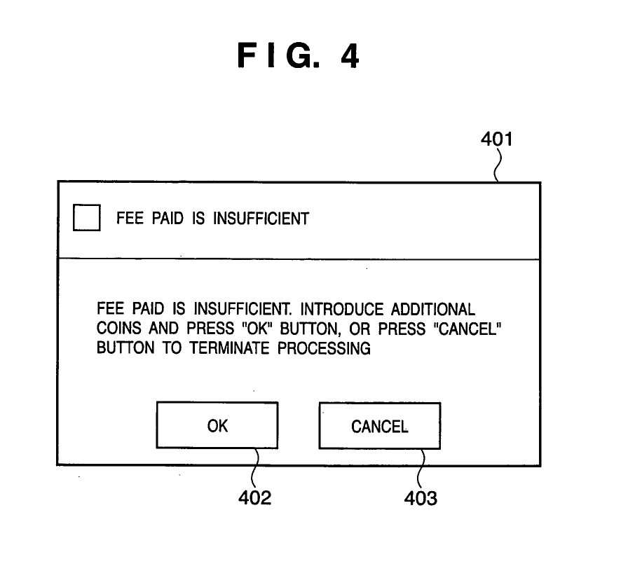

On the other hand, if it is determined at step S307 that the fee necessary for scan processing has not been introduced (“NO” at step S307), then the fact that the paid fee is insufficient is reported to the user and the user is prompted to perform a suitable operation (step S310). FIG. 4 is a diagram illustrating an example of a dialog box 401 displayed on the display unit 103 according to this embodiment when a fee insufficiency has occurred. In this embodiment, the user is notified of insufficient payment of the fee by displaying the dialog box 401 of FIG. 4 on the display unit 103. By so notifying the user, the image processing apparatus 201 prompts the user to press an OK button 402 or CANCEL button 403 in the dialog box 401.

If it is determined that the user has pressed the OK button 402, then control returns to step S307 and the image processing apparatus 201 again determines whether the fee necessary for scan processing has been introduced. If it is determined that the user has pressed the CANCEL button 403, then the image processing apparatus 201 terminates main processing.

If it is determined at step S310 that the fee paid for the executed scan service is insufficient and that the user has pressed the CANCEL button 403, then processing is terminated without execution of charging processing. However, no notification is given of the password for decrypting the scanned image data. In other words, although storage of the scanned image data on the removable medium has ended normally, the image data has been stored in encrypted form, making it impossible for the user to decrypt the data. Accordingly, the user cannot obtain the desired results but is not charged either. The encrypted scanned image data that has been stored on the removable medium is capable of being deleted even without use of the decryption password, and the removable medium can be restored to the state that prevailed prior to storage of the scanned image data without use of the password.

In a case where charging of a fee is performed in a chargeable scanning job for scanning in a paper document to digitize the document in the image processing apparatus according to this embodiment, as described above, it is so arranged that the user cannot obtain data (e.g., a decryption password) to decrypt encrypted image data, rather than arranging it so that the fee for the scanning job is not accepted, in the event of such behavior as withdrawal of memory media or disconnection of the network during the storing of the scanned image data. As a result, it is possible to eliminate a situation in which the administrator or installer of an image processing apparatus fails to obtain due profit, namely a situation in which a user scans in and utilizes desired image data without paying the fee. Further, a fee is not accepted prior to storage of image data. This means that if the storage destination of scanned image data has inadequate capacity and the scanned image data cannot be stored normally, the user will not be charged the fee. This has the effect of enabling the fee to be collected accurately only after the scanned image data has been stored normally. Thus, the image processing apparatus according to this embodiment, while assuring profitability to the administrator or installer of the apparatus, is capable of providing appropriate services to the user of the apparatus and of collecting the required fee. Further, the apparatus is effective in a service system in which a fee collecting device such as a coin device is installed close to the image processing apparatus, a user introduces the required fee directly and has the apparatus perform a service operation, and the administrator or installer of the image processing apparatus need not become involved in having the user make payment of the fee. To the administrator or installer of the image processing apparatus, this means that an unattended service can be provided. To the user who utilizes the service, this makes it possible to make such utilization with ease.

Although an embodiment of the present invention has been described in detail, the invention can be worked as a system, apparatus, method, program or storage (recording) medium, by way of example. More specifically, the present invention may be applied to a system constituted by a plurality of devices or to an apparatus comprising a single device.

Furthermore, there are cases where the object of the invention is attained also by supplying a software program (a program corresponding to the flowchart illustrated in the drawings of the embodiment), which implements the functions of the foregoing embodiment, directly or remotely to a system or apparatus, reading the supplied program codes with a computer of the system or apparatus, and then executing the program codes.

Accordingly, since the functions of the present invention are implemented by computer, the program codes per se installed in the computer also implement the present invention. In other words, the present invention also covers a computer program per se that is for the purpose of implementing the functions of the present invention.

In this case, so long as the system or apparatus has the functions of the program, the form of the program, e.g., object code, a program executed by an interpreter or script data supplied to an operating system, etc., does not matter.

Examples of recording media that can be used for supplying the program are a floppy (registered trademark) disk, hard disk, optical disk, magneto-optical disk, CD-ROM, CD-R, CD-RW, magnetic tape, non-volatile type memory card, ROM, DVD (DVD-ROM, DVD-R), etc.

As for the method of supplying the program, the client computer can be connected to a website on the Internet using a browser possessed by the client computer, and the computer program per se of the present invention or an automatically installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer also is covered by the claims of the present invention.

Further, it is also possible to encrypt and store the program of the present invention on a storage medium such as a CD-ROM, distribute the storage medium to users, allow users who meet certain requirements to download decryption key information from a website via the Internet, and allow these users to run the encrypted program by using the key information, whereby the program is installed in the user computer.

Furthermore, besides the case where the aforesaid functions according to the embodiment are implemented by executing the read program by computer, an operating system or the like running on the computer may perform all or a part of the actual processing so that the functions of the foregoing embodiment can be implemented by this processing.

Furthermore, after the program read from the storage medium is written to a memory provided on a function expansion board inserted into the computer or provided in a function expansion unit connected to the computer, a CPU or the like mounted on the function expansion board or function expansion unit performs all or a part of the actual processing so that the functions of the foregoing embodiments can be implemented by this processing.

In accordance with the present invention, when a chargeable scanning job is executed, utilization of scanned image data by a user who has not paid a fee can be prevented and it is possible to avoid a situation in which a user who has paid the fee cannot utilize scanned image data.

As many apparently widely different embodiments of the present invention can be made without departing from the spirit and scope thereof, it is to be understood that the invention is not limited to the specific embodiments thereof except as defined in the appended claims.

This application claims the benefit of Japanese Patent Application No. 2005-168416 filed on Jun. 8, 2005, which is hereby incorporated by reference herein in its entirety.

What is claimed is:

1. An image processing apparatus for executing a chargeable scanning job, comprising:
a data generating unit adapted to scan a document and generate data;
an encrypting unit adapted to encrypt the data and generate encrypted data;
a charging unit adapted to execute charging processing with regard to price of the chargeable scanning job after the encrypted data has been stored at a predetermined storage destination; and
an output unit adapted to output information necessary when the stored encrypted data that has been stored at the storage destination is decrypted, after the charging processing is executed.

2. The apparatus according to claim 1, further comprising a storing unit adapted to store the encrypted data at the storage destination.

3. The apparatus according to claim 2, further comprising a first determination unit adapted to determine whether or not storage of the encrypted data at the storage destination by said storing unit has been performed normally;
wherein said charging unit executes charging processing with regard to the price of the chargeable scanning job after the encrypted data has been stored at the storage destination normally.

4. The apparatus according to claim 2, further comprising a second determination unit adapted to determine whether or not the storage destination at which the encrypted data is to be stored by said storing unit has enough capacity to store the encrypted data;
wherein said storing unit stores the encrypted data in a case where the storage destination has enough capacity to store the encrypted data.

5. The apparatus according to claim 1, wherein said output unit prints out the information on a printing medium.

6. The apparatus according to claim 2, wherein said storing unit stores the encrypted data on a storage medium that is removably inserted into said image processing apparatus.

7. The apparatus according to claim 6, further comprising an alerting unit adapted to issue an alert in a case where the storage medium is extracted from said image processing apparatus before the encrypted data has been stored on the storage medium normally by said storing unit;
wherein said output unit inhibits output of the information in a case where the encrypted data has not been stored normally owing to extraction of the storage medium.

8. The apparatus according to claim 2, wherein storing unit stores the encrypted data at a storage destination administered by an external device connected to said image processing apparatus via a network.

9. The apparatus according to claim 8, further comprising an alerting unit adapted to issue an alert in a case where a network connection to the external device is disconnected before storage of the encrypted data at the storage destination administered by the external device is performed normally by said storing unit;
wherein said output unit inhibits output of the information in a case where storage of the encrypted data has been performed abnormally owing to disconnection between the network connection and the external device.

10. An image processing method for executing a chargeable scanning job, comprising:
a data generating step of scanning a document and generating data;
an encrypting step of encrypting the data and generating encrypted data;
a charging step of executing charging processing with regard to price of the chargeable scanning job after the encrypted data has been stored at a predetermined storage destination; and
an output step of outputting information necessary when the encrypted data that has been stored at the storage destination is decrypted, after the charging processing is executed.

11. A program for causing an image processing apparatus for executing a chargeable scanning job to execute the following steps:
a data generating step of scanning a document and generating data;
an encrypting step of encrypting the data and generating encrypted data;
a charging step of executing charging processing with regard to price of the chargeable scanning job after the encrypted data has been stored at a predetermined storage destination; and
an output step of outputting information, which is used when the encrypted data that has been stored at the storage destination is decrypted, after the charging processing is executed.

12. A computer-readable storage medium storing the program set forth in claim 11.
